(19) United States
(12) Patent Application Publication
(10) Pub. No.: US 2022/0211210 A1
(43) Pub. Date: Jul. 7, 2022

(54) TEMPERATURE-CONTROL MODULE FOR CONTROLLING THE TEMPERATURE OF BABY FOOD, POUCH FOR STORING BABY FOOD, AND METHOD FOR CONTROLLING THE TEMPERATURE OF BABY FOOD

(71) Applicant: SMIICS GMBH, Göttingen (DE)

(72) Inventor: Stefan SCHLACK, Göttingen (DE)

(21) Appl. No.: 17/607,519

(22) PCT Filed: May 7, 2020
(86) PCT No.: PCT/EP2020/062672

§ 371 Date: Oct. 29, 2021

(30) Foreign Application Priority Data
May 8, 2019 (DE) 10 2019 003 274.8

(51) Int. Cl. A47J 36/24; B65D 33/02; B65D 81/32

(52) U.S. Cl. CPC A47J 36/2433; B65D 2313/04; B65D 81/3261; B65D 33/02

(57) ABSTRACT

The present invention relates to a tempering module (100) for tempering baby food, specifically baby milk or baby puree, which is designed to receive a bag (1) for baby food; and wherein the tempering module (100) comprises at least one heating element which is designed to heat an inner wall (112) of the tempering module (100) in order to control the temperature of the baby food contained in the bag (1), and wherein the tempering module (100) comprises at least one tensioning device which is designed to receive the inserted bag (1) in a state in which it is possible to place the bag (1) flat against the inner wall (112) of the tempering module (100). Furthermore, the application relates to a bag for storing baby food, specifically baby milk or baby puree, comprising at least one chamber (2; 3, 5) for receiving the baby food and a process for tempering a baby food

The present invention relates to a tempering module for tempering baby food, a bag for storing baby food, and a process for tempering baby food.

In order to have baby food available on the go, parents usually need to carry a variety of utensils to be able to make baby food for the baby as needed. Typically, a thermos of boiled water is carried, and the water must be cooled to a comfortable drinking temperature before use. In some cases, the boiled water has already cooled too far, making it too cold for the baby. Alternatively, bottles of special baby water, pre-made milk or breast milk can be taken, but these are not heated to a drinking temperature. In all cases, it is difficult or not possible to have the liquid at the appropriate drinking temperature for the baby when it is needed.

Furthermore, thermos flasks and plastic containers in which the powder (baby food concentrate) for the baby food is carried represent open systems. There is therefore a risk of contamination. In other words, both the water and the powder for the baby food can only be stored in these systems to a limited extent.

In addition, parents must carry baby bottles with nipple attachments to be able to feed the food to the baby. However, the baby bottles and nipple attachments must be cleaned and sterilized after use. For example sterilization specifically requires a stove to boil the bottles. However, a stove is usually difficult to find when travelling. In addition, cleaning and sterilizing is time-consuming.

All this means a lot of utensils for outings and especially for longer trips that parents have to carry with them and a baby food production process that regularly fails to reach the optimal drinking temperature.

It is thus the object of the present invention to provide a simple transportable system for providing baby food, which enables baby food to be prepared quickly and at an optimum temperature while on the move.

This problem is solved by the independent claims. Preferred embodiments are the subject of the dependent claims.

According to a first aspect, the problem is solved by a tempering module for tempering baby food, specifically baby milk or baby puree, which is designed to receive a bag for baby food;
wherein the tempering module comprises at least one heating element designed to heat an inner wall of the tempering module to control the temperature of the baby food contained in the bag, and
wherein the tempering module comprises at least one tensioning device which is designed to receive the inserted bag in a state in which it is possible to place the bag flat against the inner wall of the tempering module.

The “bag” represents a flexible container, which is preferably made of plastic, such as polyethylene. A composite film of polyethylene and polyamide is particularly preferred. In particular, the bag is designed for single use and can be positioned of after its use.

The bag is suitable for holding baby food which can be tempered in the tempering module. The term “baby food” is understood to mean baby milk or baby puree. Baby milk can be breast milk or a baby milk which is mixed from a powder (baby food concentrate) and water. By insertion of the bag with the baby food into the tempering module, the baby food can be tempered to drinking or eating temperature. In particular, the tempering module can also be used to heat frozen baby food, such as frozen breast milk.

The tempering module thus represents a receptacle in which a bag of baby food can be received in order to heat the baby food when required.

As the tempering module is suitable for heating bags, the user can carry pre-portioned baby food units in bags which are tempered as required. The bag can then be disposed of. There is no need to take along baby bottles and no need for the subsequent cleaning and sterilization of the baby bottles.

Preferably, the heating element is designed as a heating mat. The heating element can at least partially or completely overlap the inner wall of the tempering module. The heating element heats the inner wall of the tempering module, whereby heat is subsequently transferred from the inner wall of the tempering module to the bag that is inserted into the tempering module.

In particular, the tempering module enables rapid tempering of the baby food, since the tempering module holds the bag in the tempering module by means of the at least one tensioning device in such a way that the bag lies flat against the heated inner wall of the tempering module. Collapsing of the bag and kinks in the bag are avoided. Since the bag lies flat against the inner wall, there is no insulating air between the bag and the heated inner wall, which would prevent rapid heating.

The tempering module can be operated on the move, preferably by means of a rechargeable battery, or supplied with power via a socket and cable.

Preferably, the tempering module is comprised of a rotationally symmetrical tempering module housing with a tempering module base surface and a tempering module insertion opening via which the bag can be inserted into the tempering module housing.

It is preferred that at least one tensioning recess is formed as a tensioning device, which extends in a longitudinal direction, in the inner wall of the tempering module housing.

The “longitudinal direction” extends parallel to the axis of rotation of the tempering module housing. The tensioning recess is designed in such a way that a corresponding tensioning device, which is arranged on the bag, can be inserted into the tensioning recess via the tempering module insertion opening during insertion.

The tempering module may have only one tensioning recess. However, it is also possible that several tensioning recesses are formed in the tempering module.

Due to the tensioning recess and a tensioning device of a bag engaging in the tensioning recess, the bag can be held in an upright position in the tempering module without kinks. In particular, the bag lies flat against the inner wall of the tempering module so that rapid heating of the baby food is possible.

Alternatively, a circumferential edge on the tempering module insertion opening or a tensioning support surface adjacent to the tempering module insertion opening may form a first tensioning device.

The circumferential edge limits the tempering module insertion opening. This edge can form the first tensioning device of the tempering module. Alternatively, however, a tensioning support surface can also be formed offset inwards, which then forms the first tensioning device. In this context, “adjacent” to the tempering module insertion opening is to be understood as a distance from the tempering module insertion opening of preferably up to 3 cm. In order to form the tensioning support surface, the diameter of the interior of the tempering module widens. At the point where the diameter of the interior of the tempering module expands, a tensioning support surface is formed which preferably extends perpendicularly to the longitudinal direction.

When the bag is inserted into the tempering module, an appropriate tensioning device may rest on the bag on the circumferential edge or tensioning support surface so that the bag is prevented from covering into the tempering module.

In addition, at least one magnet may be arranged in or on the tempering module base surface as a second tensioning device.

The at least one magnet is thereby designed to be connected to a magnet in or on the bag.

Thus, at opposite ends of the interior of the tempering module there are tensioning devices with respect to the longitudinal direction, which make it possible to hold the bag in the tempering module in such a way that kinks are avoided and the bag can be held flat against the inner wall. This allows the baby food to be quickly tempered in the tempering module.

As an alternative to the magnet, a tensioning opening may be formed in the tempering module base surface as a second tensioning device configured to guide a tensioning strap attached to the inserted bag out of the tempering device.

In the inserted state, the tensioning strap emerges at least partially from the tempering module via the tensioning opening and can be manually pulled out further by the user. By pulling out the tensioning tab, the bag can be held in the tempering module in addition to the bag resting on the first tensioning device at the upper end of the tempering module in such a way that the bag can be held flat against the inner wall. In this way, the baby food can be quickly tempered in the tempering module.

As an alternative to a magnet or a tensioning opening, a circumferential tensioning recess may be formed in the inner wall of the tempering module housing adjacent to the tempering module base surface as a second tensioning device.

“Adjacent” to the tempering module base surface is also understood here to mean a distance from the tempering module base surface with respect to the longitudinal direction of preferably a maximum of 3 cm. The circumferential tensioning recess is formed by an area in the inner wall of the tempering module in which the diameter of the interior of the tempering module expands. The circumferential tensioning recess is thereby formed by a surface at which the diameter of the inner space of the tempering module expands. Preferably, the surface extends perpendicular to the longitudinal direction. In particular, it is preferred that the interior of the tempering module expands between the circumferential tensioning recess and the tempering module base surface.

A corresponding tensioning device on the inserted bag can engage in the circumferential tensioning recess. In this way, in addition to the bag resting on the first tensioning device at the upper end of the tempering module, the bag can be held in the tempering module in such a way that the bag can be held flat against the inner wall. Thus, the baby food can be quickly tempered in the tempering module.

Preferably, the tempering module housing can be opened.

This is particularly preferred when the second tensioning device is formed as a circumferential tensioning recess. Preferably, the tempering module can be opened along the longitudinal direction to ensure insertion of the tensioning device into the circumferential tensioning recess as a second tensioning device.

According to another aspect of the present invention, the underlying problem is solved by a bag for storing baby food, specifically baby milk or baby puree, comprising at least one chamber for containing baby food;
wherein the chamber has an opening for filling the chamber;
wherein a connecting element is arranged at the opening;
wherein a first tensioning device is formed on an outer side of the connecting element, wherein the first tensioning device comprises a tensioning projection that runs around at least in some regions;
wherein a second tensioning device is at one end of the bag which is opposite to the end at which the connecting element is arranged, wherein the first and second tensioning device are designed to hold the bag inserted into a tempering module, preferably a tempering module according to one of claims 1 to 8, in such a way that the bag can be laid flat against an inner wall of the tempering module.

Definitions of a bag, which have already been made with regard to the tempering module, also apply here accordingly.

At a first end of the bag adjacent to the opening of the bag is the connecting element, which is connected to the flexible bag at the opening of the bag. In contrast to the bag, the connecting element is made of a rigid material, preferably a rigid plastic.

A second tensioning device is located at a second end of the bag opposite the first end of the bag. A direction extending between the first and second ends of the bag is referred to as the “longitudinal bag direction”.

On an outer side of the connecting element, a tensioning projection is formed as a first tensioning device, that is formed around at least in some regions. The outer side is preferably understood to be the side of the connecting element which extends along the longitudinal direction of the bag. Due to the at least partially circumferential tensioning projection, the connecting element expands along the corresponding area.

The tensioning device of the bag are designed to receive the bag in a tempering module in such a way that the bag can lie flat against an inner wall of the tempering module. The bag is prevented from collapsing and forming kinks in the bag. In particular, insulating air between the bag and the inner wall of the tempering module is avoided, so that rapid heating of the baby food can be achieved.

According to a preferred embodiment, the bag comprises one chamber.

Bags with one chamber are particularly suitable for storing and transporting ready-mixed baby milk or baby puree or breast milk.

Preferably, the second tensioning device herein comprises a tensioning plate which is fastened to a base surface of the bag and in or on which at least one magnet is arranged.

The “base surface” of the bag is the surface of the bag which is located at the second end of the bag. When the bag is inserted into a tempering module, this base surface is opposite the tempering module base surface. The at least one magnet in or on the tensioning plate of the bag is designed to be connected to a corresponding magnet in or on the tempering module base surface, such that the second end of the bag is held securely against the tempering module base surface.

The first tensioning device of the bag is designed to simultaneously rest on a tensioning device on the tempering module, so that the first end of the bag cannot slip into the tempering module.

The first and second tensioning device can thus hold the bag in the tempering module such that the bag can be held flat against a heated inner wall of the tempering module, and the baby food can be heated rapidly.

Alternatively, the second tensioning device comprises a tensioning strap fastened to a base surface of the bag and extends in a longitudinal direction of the bag.

The tensioning strap is configured to extend from a tensioning opening in a tempering module to ensure that the base surface of the bag is securely pulled toward the tempering module base surface.

The first tensioning device of the bag is also configured here to simultaneously rest on a tensioning device on the tempering module, so that the first end of the bag cannot slip into the tempering module.

By such a configuration of the first and second tensioning device, the bag can thus also be held in the tempering module in such a way that the bag can be held flat against a heated inner wall of the tempering module and the baby food can be heated quickly.

Further, the tensioning projection on the connecting element may be a first tensioning projection, wherein the opening at which the connecting element is formed is a first opening;
wherein the bag comprises a second opening formed on a side of the bag opposite to the side on which the first opening is formed;
wherein a tensioning cover is formed on the second opening, which closes the second opening and on the outer side of which a second tensioning projection is formed around at least in some areas; and
   wherein the first and second tensioning projections are designed in such away that when inserted into a tempering module, the bag is flat against an inner wall of the tempering module.

At the second end of the bag there is a second opening, which is closed by a tensioning cover. The outer side of the tensioning cover is preferably defined as the side of the tensioning cover extending along the longitudinal direction of the bag. On this outer side, there is a second tensioning projection which is circumferential for at least part of the projection. The size and position of the second tensioning projection can be freely selected or aligned along the longitudinal axis of the bag with a first tensioning projection.

The tensioning cover is designed as a rigid element, similar to the connecting element.

The first and second tensioning projections are designed to each engage a respective tensioning device in the tempering module, such that the bag is held in the tempering module so that the bag is held flat against a heated inner wall of the tempering module and the baby food can be rapidly heated.

Alternatively, the tensioning projection on the connecting element may be a first tensioning projection and the opening at which the connecting element is formed may be a first opening;
wherein the bag comprises a second opening formed on a side of the bag opposite to the side on which the first opening is formed;
wherein a tensioning cover is formed on the second opening, which closes the second opening and on the outer side of which a second tensioning projection is formed around at least in some areas; and
wherein the second tensioning projection comprises at least one tensioning strut extends in a longitudinal direction of the bag and connected to the first tensioning projection.

The above description of the tensioning cover and the first and second tensioning projections also applies here accordingly.

In addition, however, the second tensioning projection here has at least one tensioning strut which extends along the longitudinal direction of the bag and is connected to the first tensioning projection. Due to the supporting force of the tensioning strut, the connecting element and the tensioning cover can be held at a stable distance from one another with respect to the longitudinal direction of the bag. The length of the tensioning strut should preferably be selected so that the bag does not have any kinks.

In particular, the tensioning strut may be designed to be inserted into a tensioning device in a tempering module along a longitudinal direction. This can further ensure that the bag lies flat against the inner wall of the tempering module, in order to quickly temper the baby food in the bag.

Preferably, the connecting element is designed to be connected to a breast pump and/or a dispenser for filling the chamber.

It is further preferred that the bag comprises a first chamber and a second chamber which are separated from one another by a separating area;

the first chamber being designed to contain a baby food concentrate;
wherein the second chamber is designed to receive a fluid;
wherein the first and second chamber are arranged along a longitudinal bag direction of the bag;
wherein the separating region can be at least partially opened by applying force to the bag in order to be able to mix the components contained in the first and second chamber to forma a baby food;
wherein the connecting element having the first tensioning projection is a first connecting element and wherein the opening at which the first connecting element is arranged is a first opening;
wherein a second opening is formed on an end opposite to the end at which the first connecting element is formed; and
wherein a second connecting element is formed on the second opening.

The bag contains two chambers which are separated from one another by a separating region so that the baby food concentrate and the fluid cannot come into contact with each other and be mixed before use.

In particular, the chambers are arranged along the longitudinal direction of the bag with the opposite ends of the bag being open. Here, a first opening is adjacent to the first chamber and a second opening is adjacent to the second chamber. Via the openings, the chambers can be filled (e.g. by the parents) with contents (e.g. the fluid and the baby food concentrate) in advance (e.g. at home). Preferably, the openings can subsequently be closed by means of a first and a second closure respectively. In this way, the baby food is already pre-portioned and can be mixed if necessary. Since the individual components of the baby food are stored separately, the baby food or the contents of the bag have a longer shelf life.

For mixing, the user applies force to the bag to at least partially break open or open the separating region so that the individual components or the content(s) of the bag can mix and the baby food can be produced. By shaking the bag, an optimal mixture can be produced.

The second connecting element is preferably also formed as a rigid element.

Preferably, the second tensioning device comprises at least one magnet arranged in or on a closure which can be connected to the second connecting element.

In a bag with two chambers, the at least one magnet is positioned in or on a closure which closes the second opening. The at least one magnet in or on the closure is thereby designed to be connected to a corresponding magnet in or on the tempering module base surface so that the second end of the bag is securely held to the tempering module base surface.

The first tensioning device of the bag is designed to simultaneously rest on a tensioning device on the tempering module, so that the first end of the bag cannot slip into the tempering module.

The first and second tensioning device can thus hold the bag in the tempering module such that the bag can be held flat against a heated inner wall of the tempering module, and the baby food can be heated rapidly.

Alternatively, the second tensioning device may comprise a tensioning strap attached to a closure which can be connected to the second connecting member, the tensioning strap extends along the bag's longitudinal direction.

The tensioning strap is configured to extend from a tensioning opening in a tempering module to ensure that the base surface of the bag is securely pulled toward the tempering module base surface.

The first tensioning device of the bag is also configured here to simultaneously rest on a tensioning device on the tempering module, so that the first end of the bag cannot slip into the tempering module.

By such a configuration of the first and second tensioning device, the bag can thus also be held in the tempering module in such a way that the bag can be held flat against a heated inner wall of the tempering module and the baby food can be heated quickly.

Furthermore, a second tensioning projection may alternatively be formed around at least in some areas, on the outer side of the second connecting element; and
wherein the first and second tensioning projections are designed, in such a way that when inserted into a tempering module, the bag is flat against an inner wall of the tempering module.

At the second end of the bag there is a second opening at which a second connecting element is arranged. The outer side of the second connecting element is preferably defined as the side of the second connecting element which extends along the longitudinal direction of the bag. On this outer side, there is formed around at least in some areas a second tensioning projection. The size and position of the second tensioning projection can be freely selected or aligned along the longitudinal axis of the bag with a first tensioning projection.

The first and second tensioning projections are designed to each engage a respective tensioning device in the tempering module, such that the bag is held in the tempering module flat against a heated inner wall of the tempering module and the baby food can be rapidly heated.

Furthermore, a second tensioning projection may alternatively be formed around at least in some areas on the outer side of the second connecting element; and
wherein the second tensioning projection comprises at least one tensioning strut extending along the longitudinal direction of the bag and connected to the first tensioning projection.

The definition of the “outer side” of the second connecting element is identical to the outer side already defined above. In addition, the description above regarding the first and second tensioning projections also applies here accordingly.

In addition, however, the second tensioning projection here has at least one tensioning strut which extends along the longitudinal direction of the bag and is connected to the first tensioning projection. Due to the supporting force of the tensioning strut, the connecting element and the tensioning cover can be held at a stable distance from one another with respect to the longitudinal direction of the bag. The length of the tensioning strut should preferably be selected so that the bag does not have any kinks.

In particular, the tensioning strut may be designed to be inserted into a tensioning device in a tempering module along a longitudinal direction. This can further ensure that the bag lies flat against the inner wall of the tempering module, so as to quickly temper the baby food in the bag.

Preferably, the first and second connecting elements are designed to be which can be connected to a dispenser such that the corresponding chamber can be filled by the dispenser.

Furthermore, it is preferred that the connecting element is which can be connected to a nipple.

This allows the baby to consume the tempered baby food directly from the bag.

If the bag has two chambers, the nipple can be connected to at least one of the connecting elements.

According to another aspect of the present invention, the underlying problem is solved by a process for tempering a baby food, specifically baby milk or baby puree, which comprises:
Providing a tempering module according to any of the embodiments described above;
Providing a bag according to any of the embodiments described above, which is filled with baby food;
insertion of the bag into the tempering module in such a way that the bag is hold flat against the inner wall of the tempering module by the tensioning device of the bag and the at least one tensioning device of the tempering module; and
tempering the baby food.

Preferably, providing a bag comprises providing a bag having one chamber,
wherein the bag is inserted into the tempering module such that the tensioning projection on the connecting element rests on the first tensioning device of the tempering module and the at least one magnet on the bag makes contact with the at least one magnet in or on the tempering module base surface.

Alternatively, providing a bag, may comprise providing a bag having one chamber
wherein the bag is inserted into the tempering module in such a way that the tensioning projection on the connecting element rests on the first tensioning device of the tempering module and the tensioning strap of the bag is at least partially withdrawn from the tensioning opening in the base surface of the tempering module.

Further, providing a bag may comprise providing a bag having one chamber,
wherein the bag is inserted into the tempering module in such a way that the first tensioning projection on the connecting element rests on the first tensioning device of the tempering module and the second tensioning projection on the tensioning cover engages in the second tensioning device of the tempering module.

Alternatively, providing a bag may comprise providing a bag having two chambers,
wherein the separating region is at least partially opened by applying force and the components contained in the first and second chamber are mixed together to form a baby food before the bag is inserted into the tempering module.

Preferably, the bag is inserted into the tempering module such that the at least one tensioning strut of the bag is inserted into the longitudinal direction into the tensioning recess of the tempering module.

Preferably, the bag is inserted into the tempering module such that the tensioning projection on the first connecting element rests on the first tensioning device of the tempering module and the at least one magnet of the bag makes contact with the at least one magnet in or on the tempering module base surface.

Preferably, the bag is inserted into the tempering module such that the tensioning projection on the first connecting element rests on the first tensioning device of the tempering module and the tensioning strap of the bag is at least partially withdrawn from the tensioning opening in the tempering module base surface.

Furthermore, it is preferred that the bag is inserted into the tempering module in such a way that the tensioning projection on the first connecting element rests on the first tensioning device of the tempering module and the second tensioning projection on the second connecting element engages in the second tensioning device of the tempering module.

These and other objectives, features and advantages of the present invention will become clearer from a study of the following detailed description of preferred embodiments and the accompanying drawings. Further, it is noted that although embodiments are described separately, individual features of these embodiments may be combined to form additional embodiments.

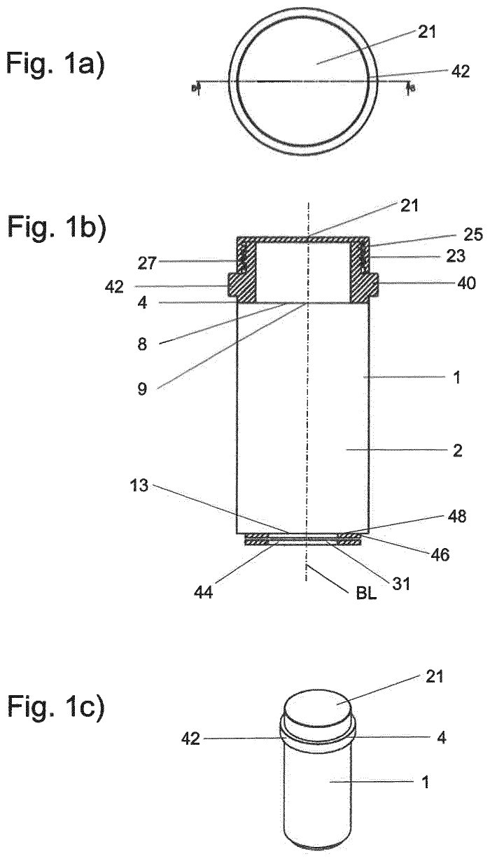

FIG. 1 shows a first embodiment of a bag for storing baby food;

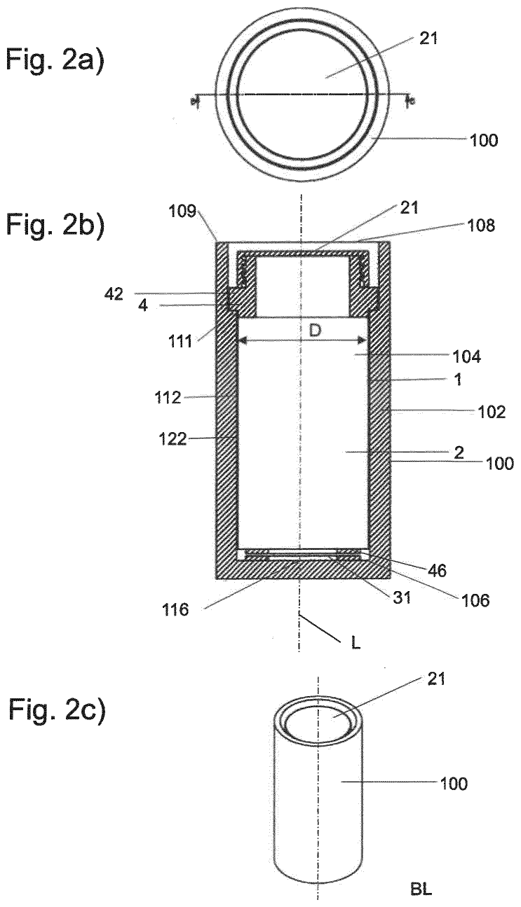

FIG. 2 shows a first embodiment of a tempering module with an inserted bag according to FIG. 1;

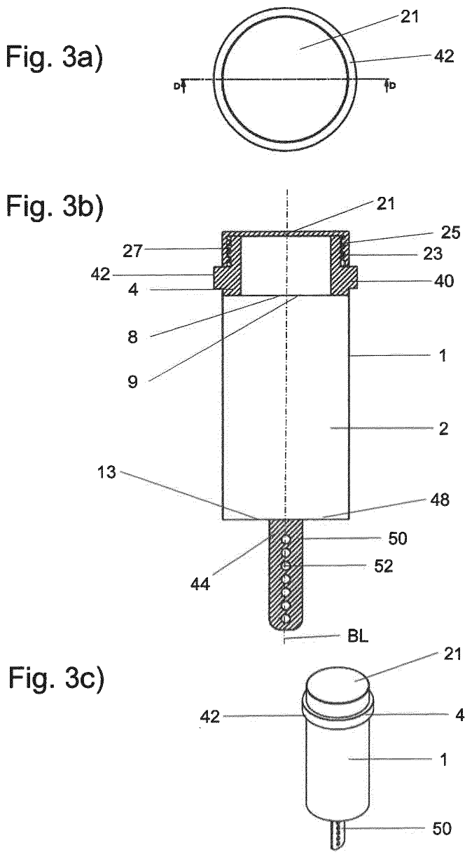

FIG. 3 shows a second embodiment of a bag for storing baby food;

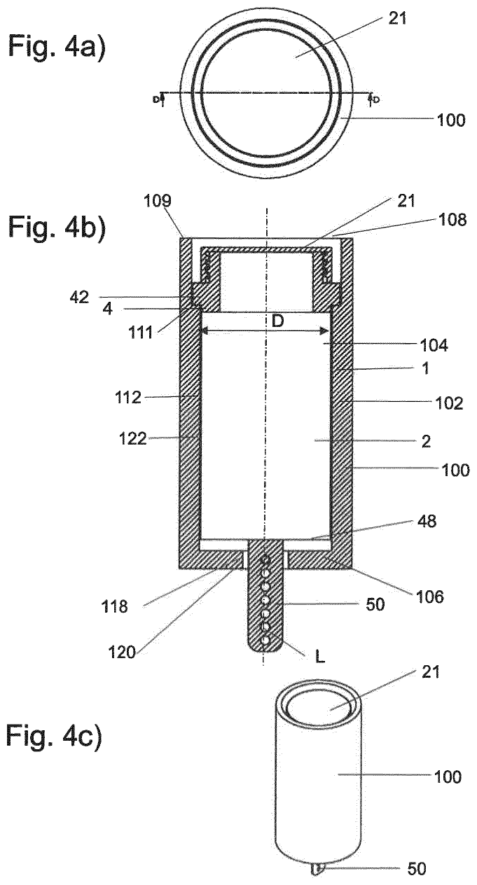

FIG. 4 shows a second embodiment of a tempering module with an inserted bag according to FIG. 3;

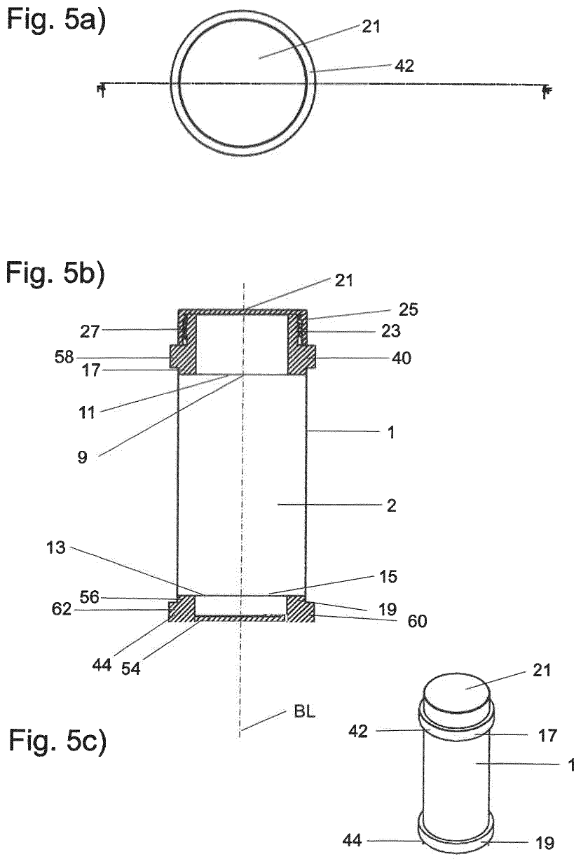

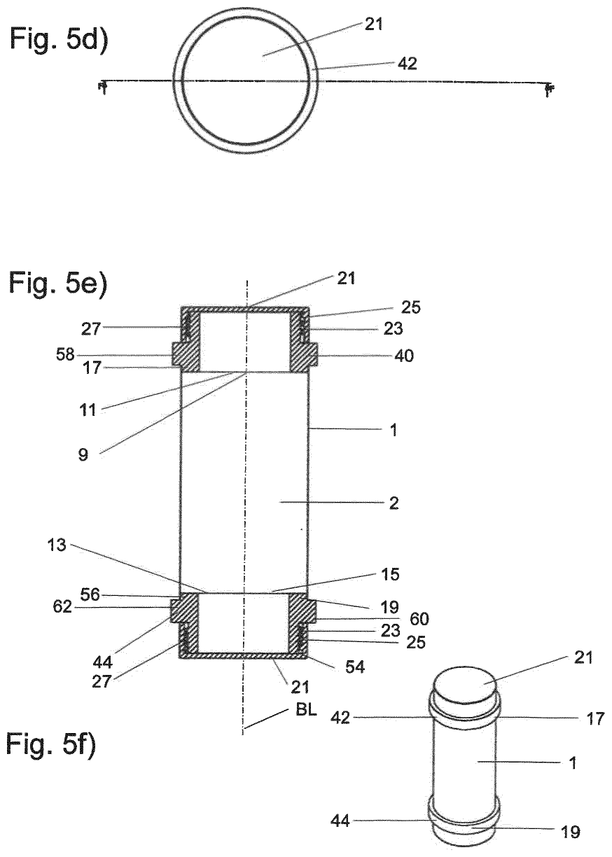

FIG. 5 shows a third embodiment of a bag for storing baby food;

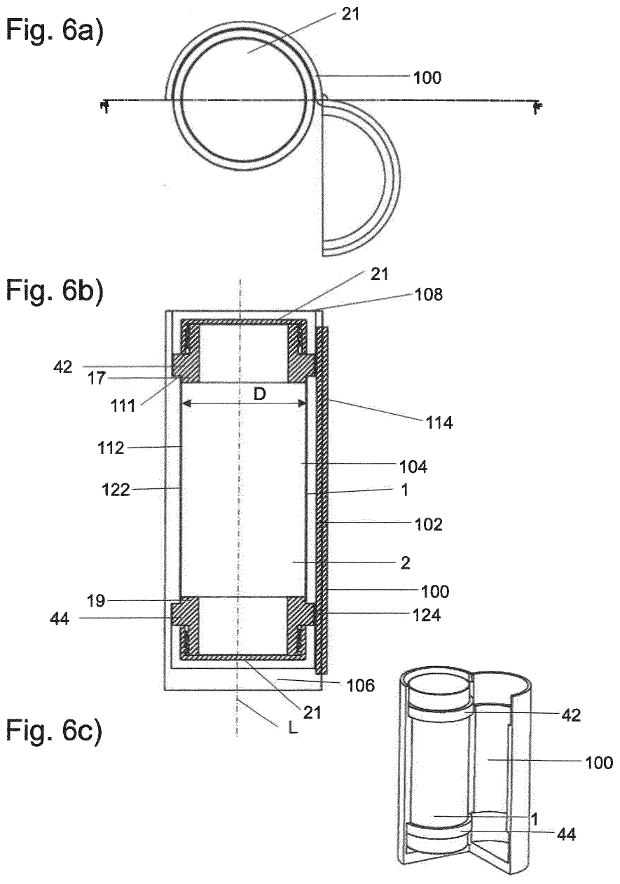

FIG. 6 shows a third embodiment of a tempering module with an inserted bag according to FIG. 5;

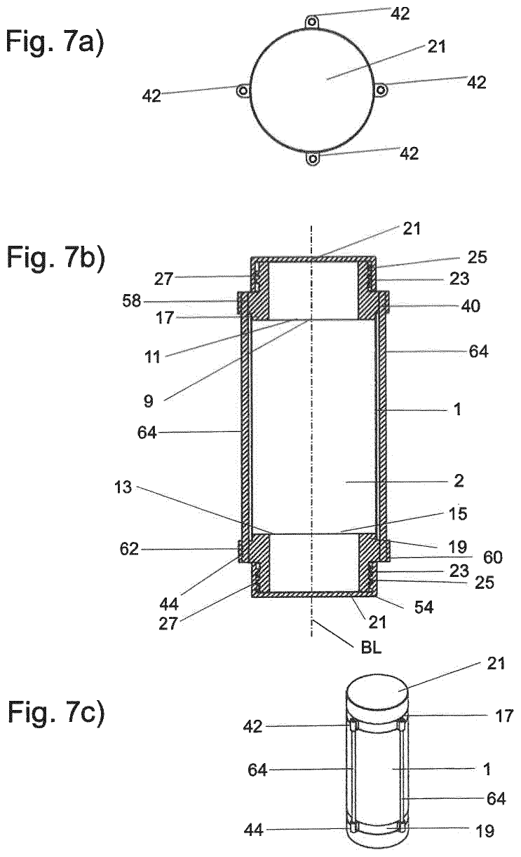

FIG. 7 shows a fourth embodiment of a bag for storing baby food;

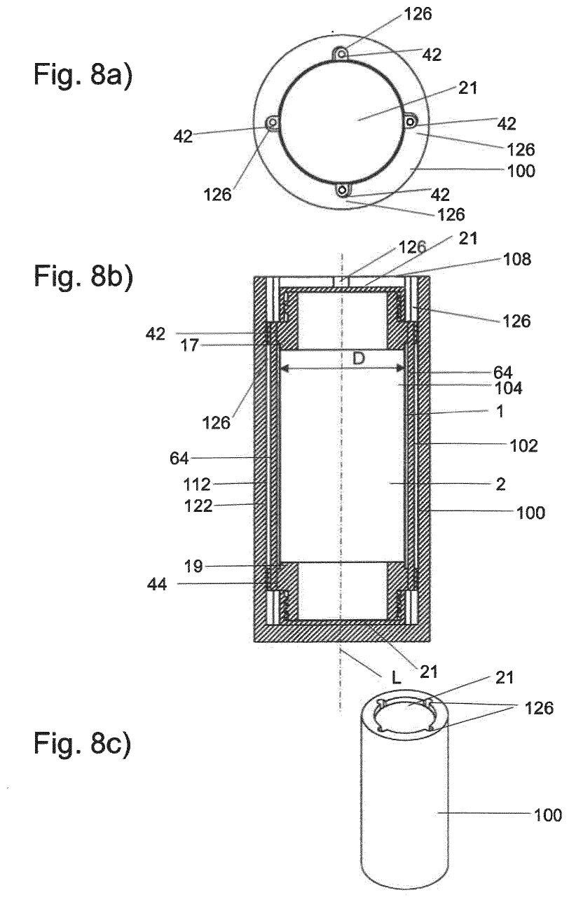

FIG. 8 shows a fourth embodiment of a tempering module with an inserted bag according to FIG. 7;

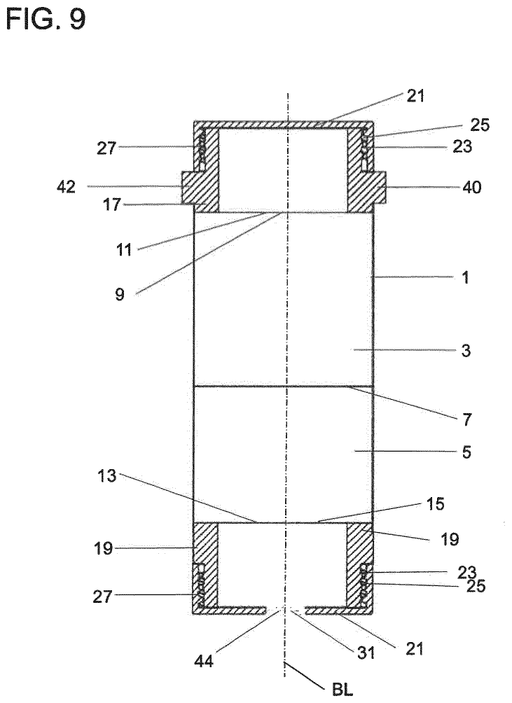

FIG. 9 shows a bag according to the first embodiment with two chambers;

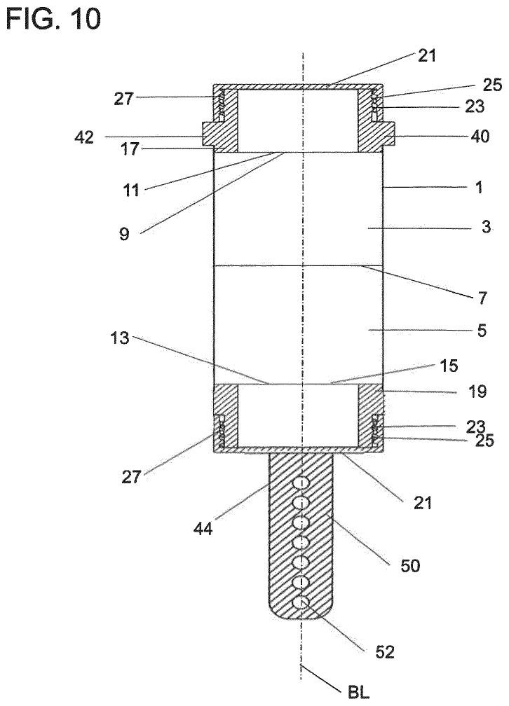

FIG. 10 shows a bag according to the second embodiment with two chambers;

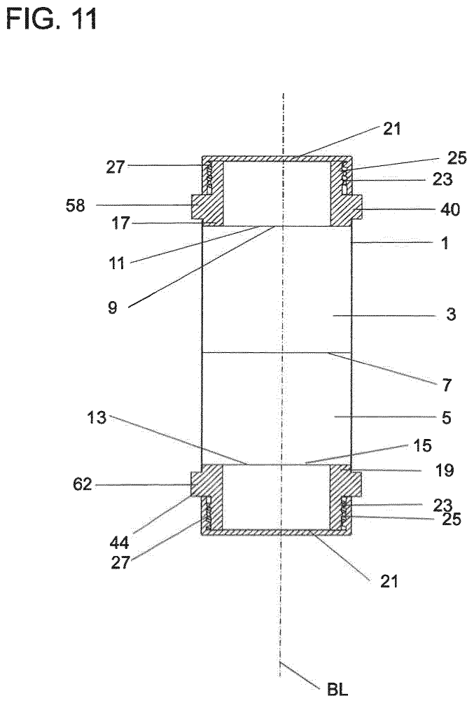

FIG. 11 shows a bag according to the third embodiment with two chambers;

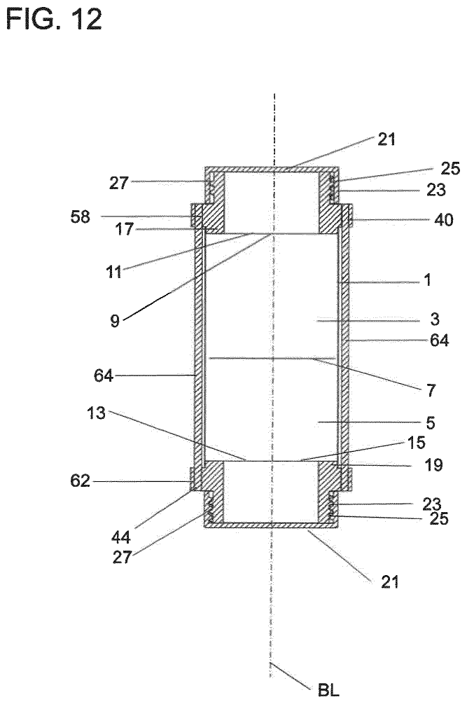

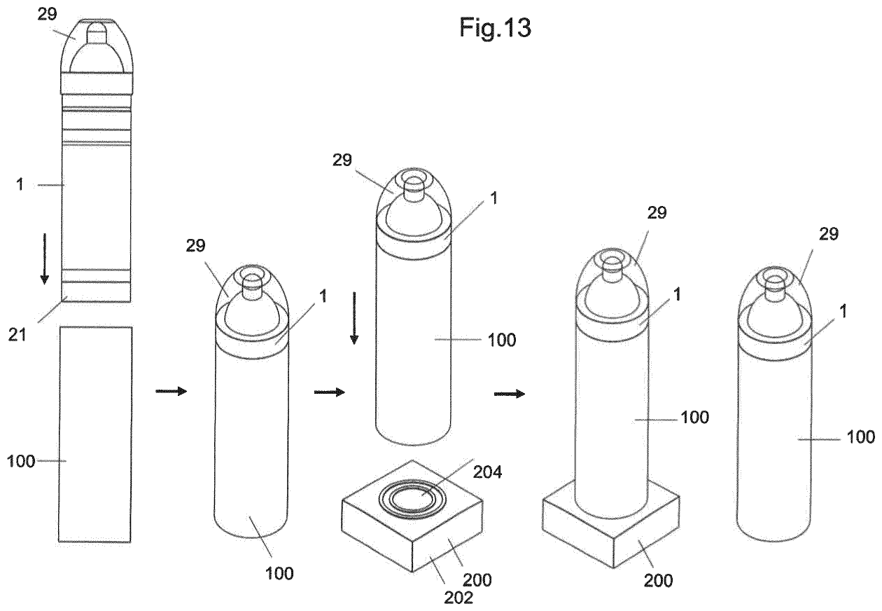

FIG. 12 shows a bag according to the fourth embodiment with two chambers FIG. 13 shows a tempering process according to a preferred embodiment for tempering the baby food in the bag; and

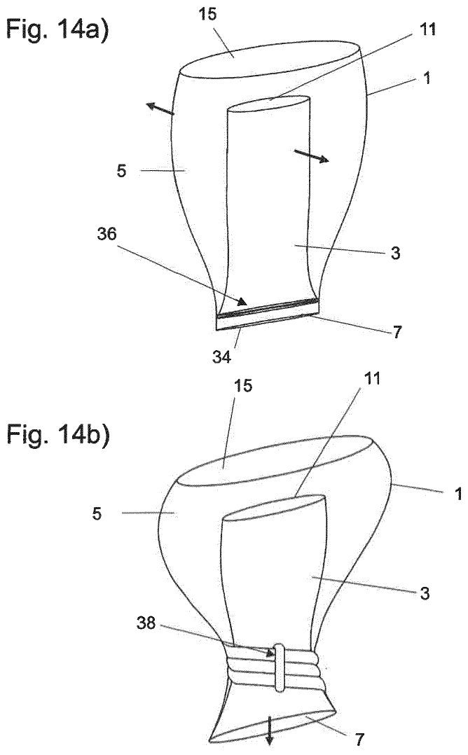

FIG. 14 shows further embodiments of a separating region for a bag with two chambers.

Various embodiments of tempering modules 100, into each of which a bag 1 of baby food is at least partially insertable to tempering the baby food, are described below.

FIG. 1 shows a first embodiment of a bag 1. FIG. 1a) shows a top view of the bag 1, FIG. 1b) a sectional view of the bag 1 in the sectional axis B-B and FIG. 1c) a perspective view of the bag 1.

The bag 1 is preferably made of plastic (for example polyethylene or a composite film of polyethylene and polyamide) substantially in the form of a tube. In particular, the tube is made in one piece without seams and preferably has a longitudinal bag axis BL. Furthermore, the bag material may comprise thermally conductive particles, preferably aluminium and/or copper particles, which allow an improved tempering of the baby food in the bag 1.

The bag 1 comprises one chamber 2, which is accessible at a first end 9 via an opening 8. At a second end 13 of the bag 1, which is opposite to the first end 9, the bag 1 is closed, preferably by a welding seam. The longitudinal bag axis BL extends from the first end 9 to the second end 13 of the bag 1. In particular, the opening 8 is designed to be filled with a baby food. For example, pre-made baby milk or baby formula, or breast milk may be filled into the bag 1.

In order to close the chamber 2 for transport, the opening 8 in the bag 1 may be closed by means of an appropriate closure. For this purpose, a connecting element 4 may be provided at the opening 8. The connecting element 4 can thereby be formed as an circular element, which is preferably made of plastic. In particular, it is advantageous here if the connecting element 4, in contrast to the bag 1 itself, is designed to be rigid or to have a higher rigidity. In order to connect the connecting element 4 to the bag 1, the connecting element 4 may be welded to the bag 1.

As shown in FIG. 1b), the closure can be designed as a cover 20 which can be connected to the connecting element 4. The cover 20 may be connected to the connecting element 4 by means of a hooking or clicking mechanism. Alternatively, the connecting element 4 and/or the cover 20 may have one or more sealing lips which, when in contact with the other element, have both a sealing and a fixing function. FIG. 1b), on the other hand, shows a screw mechanism. On an outer surface 23 (“outside”) of the connecting element 4 and on an inner surface 25 of the cover 20 there is in each case, at least in some areas, a thread 27 which engages in one another or interacts with one another in the connection process. The outer surface 23 thereby preferably runs parallel to the longitudinal axis BL of the bag.

In particular, the connecting element 4 can also be used to be connected to a dispenser designed, for example, to dispense ready-made baby food into the chamber 2. In particular, it is preferred that the bag 1 is compatible with a dispenser such as published in the publication WO 2017/121638 A1 and/or in the German patent application DE 10 2018 009 551, which are incorporated herein by reference in their entirety. The connecting element 4 may be connected to the dispenser directly herein or by means of an adapter. The amount of baby food can be manually adjusted on the dispenser. Alternatively, the dispenser dispenses predetermined or pre-portioned units to the bag 1. However, the dispenser may also comprise a sensor that automatically detects a connected bag 1 and, additionally, the size of the bag 1. Alternatively, an RFID tag could be provided or incorporated in or on the connecting element 4 for this purpose. As soon as the dispenser recognizes a bag 1, a corresponding amount of a baby food can subsequently be dispensed automatically. Due to the compatibility with a dispenser, the chamber 2 can thus be filled quickly and precisely.

Alternatively or additionally, the connecting element 4 may be connected to a breast pump for expressing breast milk.

The bag size is thereby designed such that preferably between 50 ml and 300 ml of baby food can be filled in. A size which allows 250 ml of baby food to be filled in is particularly preferred. Furthermore, the bag 1 may be folded in certain areas so that the chamber 2 is reduced in size. The fold may be unfolded as required. The folded area can be fixed with an adhesive strip and/or a clip.

In order to be able to temper the filled baby food if necessary, the bag 1 is to be inserted into a tempering module 100, as shown for example in FIG. 2, whose tempering module interior 104 can be tempered. In particular, the tempering module interior 104 can be tempering led by a heated inner wall 112.

However, since the bag 1 is a flexible container, the bag 1 often has kinks where the bag 1 buckles. In other words, the bag 1 itself cannot be held in an upright position. In particular, at the buckling points, in a state inserted into the tempering module 100, air is present between the bag 1 and the inner wall 112 of the tempering module 100, which has an insulating effect and thus deteriorates or slows down heat transfer to the bag 1 or the baby food.

In order to ensure that such kinks are avoided and that the bag 1 lies flat against the inner wall 112 of the tempering module 100, the bag 1 comprises various tensioning devices which can hold the bag 1 in an upright position in the tempering module 100.

As shown in FIGS. 1b) and 1c), the bag 1 according to the first embodiment has a first tensioning device 40 on the connecting element 4, which is formed as a tensioning projection 42, running around at least in some areas. The at least in some areas circumferential tensioning projection 42 is located, on the outer surface 23 of the connecting element 4, so that the diameter of the connecting element 4 is increased by the tensioning projection 42 which is formed around at least in some areas.

Additionally, the bag 1 comprises a second tensioning device 44 at the second end 13 of the bag. The second tensioning device 44 comprises a tensioning plate 46, which is fastened to a base surface 48 of the bag 1. At least one magnet 31 is located on or in the tensioning plate 46.

FIG. 2 shows a first embodiment of a tempering module 100 in which, for example, the bag 1 according to FIG. 1 can be inserted and which comprises tensioning devices which can be connected to the tensioning device of the bag 1 in order to hold the bag 1 in an upright position in the tempering module 100. In particular, this allows the bag 1 to be held flat against the inner wall 112 of the tempering module 100 to ensure rapid heating of the baby food.

FIG. 2a) shows a top view of the tempering module 100, FIG. 2b) a sectional view of the tempering module 100 in the sectional axis B-B and FIG. 2c) a perspective view of the tempering module 100.

The tempering module 100 comprises a tempering module housing 102, which is preferably rotationally symmetrical in shape. However, only the tempering module interior 104 may be rotationally symmetrical in shape, while the exterior shape of the tempering module housing 102 is freely selectable. In addition, the tempering module housing 102 has a tempering module base surface 106. On a side opposite to the tempering module base surface 106, there is a tempering module insertion opening 108 via which the bag 1 is at least partially insertable into the tempering module 100.

During the tempering process, the tempering module insertion opening 108 may be closed by a cover (not shown). However, it is also possible that a nipple positioned on the bag 1 and which can be connected to the connecting element 4 substantially closes the tempering module insertion opening 108. In particular, it is preferred that the diameter of the circumferential tensioning projection 42 on the connecting element 4 is larger than the diameter of the tempering module insertion opening 108, so that the connecting element 4 can be prevented from covering into the tempering module interior 104. In this case, the circumferential tensioning projection 42 would rest on a circumferential edge 109 of the tempering module 100, which outwardly limits the tempering module insertion opening 108. Alternatively, as shown in FIG. 2b), the diameter D of the tempering module interior 104 may expand in an area adjacent the tempering module insertion opening 108 to form a step as a tensioning support surface 111. It is preferred that the diameter D of the tempering module interior 104 is expanded from the tempering module insertion opening 108 to the tensioning support surface 111. When the bag 1 is inserted into the tempering module interior 104, the circumferential tensioning projection 42 can rest on the tensioning support surface 111 so that the connecting element 4 can be prevented from covering into the tempering module interior 104. According to an embodiment, the circumferential edge 109 of the tempering module 100 and the tensioning support surface 111 thus serve as a “first tensioning device”. To lock the bag 1 in the tempering module 100, the tensioning projection 42 may be clicked onto the circumferential edge 109 or the tensioning support surface 111.

More preferably, the tempering module 100 has a height H of from about 80 mm to about 130 mm. Preferably, the wall thickness of the tempering module 100 is in a range between about 0.5 mm and about 1.0 mm. A wall thickness of about 0.8 mm is particularly preferred. The diameter D of the tempering module 100 is preferably between about 45 and about 70 mm.

The height H of the tempering module interior 104 is preferably set such that the bag 1 can be arranged in a preferably stretched position in the tempering module interior 104. In this way, a faster tempering of the contents of the bag 1 or of the baby food can be achieved. The height H of the tempering module interior 104 can thereby either be defined by the length of the tempering module 100 as such, or can be combined as desired by tempering module extension elements. The individual tempering module extension elements may be clicked together or screwed together. If the tempering module 100 has multiple extension elements, the uppermost extension element has the first tensioning device.

At least one heating element is arranged on at least one portion of the inner wall 112 of the tempering module housing 102. The heating element can heat the inner wall 112 of the tempering module housing 102, preferably the heating element is located outside the tempering module interior 104. In other words, the inner wall 112 can be tempered from the outside by the heating element and the heat is transferred to the tempering module interior 104 via the inner wall 112. Preferably, the heating element may be formed as a heating mat 122 that overlaps the inner wall 112 of the tempering module housing 102, at least in some areas. Alternatively, the heating element may be formed as a heating plate, heating foil, or heating board. In the following, however, only the heating mat 122 is discussed by way of example. However, the explanations also apply to the other alternatives of a heating element.

Preferably, the inner wall 112 of the tempering module housing 102 is at least partially made of a thermally conductive material, such as aluminum or copper. For this purpose, the inner wall 112 may be manufactured as a tubular element made of aluminum or copper. As manufacturing tolerances for the diameter of the tubular element, +/−1 mm is preferred. Via this, the heat generated by the heating mat 122 can be substantially evenly distributed via the tempering module housing 102 and delivered into the tempering module interior 104. Thus, the contents of the bag 1 or the baby food can be heated evenly.

In order to achieve the fastest possible tempering of the content of the bag 1 or the baby food, the tempering module interior 104 is dimensioned in relation to the bag 1 such that the bag 1 is in surface contact with the inner wall 112 when inserted. The more surface area of the bag 1 in contact with the inner wall 112, the faster heating can occur. If the tempering module housing 102 comprises a plurality of tempering module extension elements 110, each tempering module extension element 110 preferably comprises at least one heating element. In order to provide power to each of the heating elements on the tempering module extension elements 110, it is necessary to provide connectivity between the tempering module extension elements 110 that allows power to be transferred to the individual heating elements.

As already mentioned above, it is additionally advantageous if heat-conducting particles are incorporated into the material of the bag 1. These enable an even better transfer of heat to the baby food. The particles can be aluminium or copper particles.

In addition, at least one magnet 116 may be arranged in the tempering module base surface 106 as a “second tensioning device” which, in the inserted state, interacts with the at least one magnet 31 of the bag 1 (see, for example, FIG. 1b)). The magnet 31 in or on the tensioning plate 46 of the bag 1 is arranged adjacent to the tempering module base surface 106 in the inserted state of the bag 1. This fixes the bag 1 to the tempering module base surface 106.

By the interaction of the tensioning device of the bag 1 and the tensioning devices of the tempering module 100, the bag 1 is held in an upright position and the bag 1 can be held flat against the heatable inner wall 112 of the tempering module 100. Thus, rapid heating of the baby food is possible.

FIG. 3 shows a second embodiment of a bag 1. FIG. 3a) shows a top view of the bag 1, FIG. 3b) a sectional view of the bag 1 in the sectional axis D-D and FIG. 3c) a perspective view of the bag 1.

The second embodiment of the bag 1 differs from the first embodiment of the bag 1 only in the second tensioning device 44. The rest of the embodiment of the bag 1 remains the same, so that only the differences are described here.

In particular, the second embodiment of the bag 1 does not comprise a tensioning plate 46 with at least one magnet 31, but a tensioning strap 50 which is attached to the base surface 48 of the bag 1. Preferably, the tensioning strap 50 extends in the bag's longitudinal axis BL.

The tensioning strap 50 may include one or more locating apertures 52 in the bag's longitudinal axis.

FIG. 4 shows a second embodiment of a tempering module 100 in which, for example, the bag 1 of FIG. 3 can be inserted and which comprises tensioning devices which can be connected to the tensioning device of the bag 1 of FIG. 3 in order to hold the bag 1 in an upright position in the tempering module 100. In particular, this allows the bag 1 to be held flat against the inner wall 112 of the tempering module 100 to ensure rapid heating of the baby food.

FIG. 4a) shows a top view of the tempering module 100, FIG. 4b) a sectional view of the tempering module 100 in the sectional axis D-D and FIG. 4c) a perspective view of the tempering module 100.

The tempering module 100 according to the second embodiment differs here only from the tempering module 100 of the first embodiment in the second tensioning device, so that only the second tensioning device is described here.

In particular, the second tensioning device here comprises a tensioning opening 118 in the tempering module base surface 106. The tensioning aperture 118 can be used to guide the tensioning strap 50 out of the tempering module interior 104. By pulling on the tensioning strap 50, the base surface 48 of the bag 1 can be pulled towards the tempering module base surface 106 to hold the bag 1 in an upright position in the tempering module 100 and ensure rapid heating. Preferably, in order to avoid heat loss via the tensioning opening 118, the 118 is only slightly larger than the tensioning strap 50. Preferably, a rubber seal is attached to the tensioning opening 118.

The tensioning strap 50 may be fastened to a bottom side 120 of the tempering module 100 by means of one of the fixing apertures 52. A corresponding fixing pin may be provided here on the bottom side 120 of the tempering module 100, which pin engages in the fixing aperture 52.

By the interaction of the tensioning device of the bag 1 and the tensioning devices of the tempering module 100, the bag 1 is again held in an upright position and the bag 1 can be held flat against the heatable inner wall 112 of the tempering module 100. Thus, rapid heating of the baby food is possible.

FIG. 5 shows a third embodiment of a bag 1. FIGS. 5a) and 5d) each show a top view of the bag 1, FIGS. 5b) and 5e) show a sectional view of the bag 1 in the sectional axis F-F and FIGS. 5c) and 5f) show a perspective view of the bag 1.

The third embodiment of the bag 1 differs from the first and second embodiments of the bag 1 only in the second tensioning device 44. The rest of the embodiment of the bag 1 remains the same, so that only the differences are described here.

The opening 8 of the bag 1 at the first end 9 of the bag 1 is here a first opening 11, and the tensioning projection 42 is formed around at least in some areas, on the connecting element 4 is referred to as a first tensioning projection 58. However, in this embodiment the bag 1 is not closed at the second end 13 of the bag 1, but has a second opening 15.

The second opening 15 is closed by means of a tensioning cover 54. In order to form the second tensioning device 44, the tensioning cover 54 has a second tensioning projection 62 formed around at least in some areas on an outer side 60. In this regard, the outer side 60 preferably extends parallel to the longitudinal bag axis BL. In particular, the tensioning cover 54 may be rotationally symmetrical.

If the second tensioning projection 62 is only formed in sections, the individual sections may be of equal or different sizes. The distances between the sections may be of equal or different sizes. In particular, the sections may be aligned with sections of the first tensioning projection 58 with respect to the longitudinal direction of the bag BL, or may be offset from each other.

In one aspect, the tensioning cover 54 can close the second opening 15 in such a way that the second opening 15 cannot be opened, as shown in FIGS. 5a) to 5c). In this regard, the tensioning cover 54 may preferably be formed in one piece and be fixedly connected to bag 1. However, as shown in FIGS. 5d) to 5f), the tensioning cover 54 may also be formed in two parts. Here, the connecting element 4 becomes a “first connecting element” 17 and the tensioning cover 54 itself has a second connecting element 19. On the second connecting element 19, which is connected to the bag 1, the second tensioning projection 62 is located here on the outer surface 56 thereof. The outer surface 56 of the second tensioning projection 62 preferably extends parallel to the longitudinal axis BL of the bag. Furthermore, it is preferred that the first and second connecting elements 17, 19 are identically formed. The second connecting element 19 can be closed with a closure corresponding to the first connecting element 19. As shown in FIG. 5b), the second opening 15 can be closed with a cover 21 which is screwed onto the second connecting element 19. However, other closure mechanisms as already described above are also possible here.

FIG. 6 shows a third embodiment of a tempering module 100 in which, for example, the bag 1 of FIG. 5 can be inserted and which comprises tensioning devices which can be connected to the tensioning devices of the bag 1 of FIG. 5 in order to hold the bag 1 in an upright position in the tempering module 100. In particular, this allows the bag 1 to be held flat against the inner wall 112 of the tempering module 100 to ensure rapid heating of the baby food.

FIG. 6a) shows a top view of the tempering module 100, FIG. 6b) a sectional view of the tempering module 100 in the sectional axis F-F and FIG. 6c) a perspective view of the tempering module 100.

The tempering module 100 according to the third embodiment differs here only from the tempering module 100 of the first embodiment and second embodiment in the second tensioning device, so that only the second tensioning device is described here.

As shown in FIG. 6b), in the third embodiment, the diameter D of the tempering module interior 104 expands adjacent the tempering module base surface 106 to form a step in the interior wall 112. The increase in diameter D forms a circumferential tensioning recess 124 as a second tensioning device in the tempering module 100. Preferably, the tensioning recess 124 extends with respect to a longitudinal axis L of the tempering module from the step to the tempering module base surface 106. The longitudinal axis L of the tempering module 100 extends from the tempering module insertion opening 108 to the tempering module base surface 106.

The circumferential tensioning recess 124 is configured to allow the second tensioning projection 62 of the bag 1 to be inserted. To enable such insertion, the tempering module 100 may be openable. For this purpose, the tempering module housing 102 may be divided in two with respect to the longitudinal axis L. A portion of the tempering module housing 102 may be removable or pivotable by a hinge 114 extending in the longitudinal axis L, as shown in FIG. 6.

By the interaction of the tensioning device of the bag 1 and the tensioning devices of the tempering module 100, the bag 1 is again held in an upright position and the bag 1 can be held flat against the heatable inner wall 112 of the tempering module 100. Thus, rapid heating of the baby food is possible.

FIG. 7 shows a fourth embodiment of a bag 1. FIG. 7a) shows a top view of the bag 1, FIG. 7b) a sectional view of the bag 1 and FIG. 5c) a perspective view of the bag 1.

The fourth embodiment of the bag 1 differs from the third embodiment of the bag 1 only in the second tensioning device 44. The remaining embodiment of the bag 1 remains the same, so that only the differences are described here.

More specifically, the second tensioning device 44 here additionally comprises at least one tensioning strut 64 extending in the longitudinal bag axis BL and connected to the first and second tensioning projections 58, 62. Likewise, it is possible that the tensioning strut 64 is integrally formed with the first and second tensioning projections 58, 62.

As described above, the tensioning projections 58, 62 may be formed to be either fully circumferential or only circumferential in certain areas. In particular, as shown in FIGS. 7a) to c), the portions of the tensioning projections 58,62 may be formed only where the tensioning struts 64 are formed. FIG. 7 shows four tensioning struts 64 arranged uniformly around the bag 1. However, the tensioning struts 64 can also be at different distances from one another.

FIG. 7b) shows here a tensioning cover 54 which is designed to be openable. As already described with regard to FIG. 5, the tensioning cover 54 can also be designed in such a way that the second opening 15 is firmly closed by the tensioning cover 54 and thus cannot be opened.

FIG. 8 shows a fourth embodiment of a tempering module 100 in which, for example, the bag 1 of FIG. 7 can be inserted and which comprises tensioning devices which can be connected to the tensioning device of the bag 1 of FIG. 7 in order to hold the bag 1 in an upright position in the tempering module 100. In particular, this allows the bag 1 to be held flat against the inner wall 112 of the tempering module 100 to ensure rapid heating of the baby food.

FIG. 8a) shows a top view of the tempering module 100, FIG. 8b) a sectional view of the tempering module 100 and FIG. 8c) a perspective view of the tempering module 100.

Contrary to the previously described embodiments of the tempering modules 100, the tempering module 100 of the fourth embodiment has a constant diameter D. However, the inner wall 112 here has, as a tensioning device, at least one tensioning recess 126 extending along the longitudinal direction L of the tempering module 100. In particular, the tensioning recess 126 is configured such that a corresponding tensioning strut 64 can be inserted into the tensioning recess 126. Preferably, for this purpose, the tensioning strut 64 extends from the tempering module insertion opening 108 to the tempering module base surface 106.

By the interaction of the tensioning device of the bag 1 and the tensioning device of the tempering module 100, the bag 1 is again held in an upright position and the bag 1 can be held flat against the heatable inner wall 112 of the tempering module 100. Thus, a rapid heating of the baby food is possible.

All of the embodiments of the bag 1 already described each have one chamber 2. However, the bag 1 may also have at least two chambers, as will be shown below.

FIG. 9 shows the first embodiment (see FIG. 1) of the bag 1 with two chambers.

FIG. 9 shows a bag 1 for the production of baby food according to a preferred embodiment. For the production of baby food, various baby food concentrates from different manufacturers are commercially available, which, when mixed with water, produce the required baby food. The baby food concentrate is typically in powder form. In particular, the baby food concentrate may be milk powder or a puree powder.

The bag 1 has at least one first chamber 3 and a second chamber 5, which are arranged in the bag longitudinal direction BL. FIG. 9 shows a sectional view in the longitudinal direction of the bag BL. The chambers 3, 5 are separated or separated from each other by a separating region 7, wherein the separating region 7 preferably has at least one welding seam. As shown in FIG. 9, the separating region 7 creates a necking in the bag 1.

The opposite or opposing ends of the bag 1 with respect to the bag longitudinal direction BL have openings. Specifically, at the first end 9 of the bag 1 adjacent to the first chamber 3 the first opening 11 is formed, while at the second end 13 (opposite to the first end 9) of the bag 1 adjacent to the second chamber 5 the second opening 15 is formed. The openings 11, 15 may be of the same size or of different sizes. In particular, the openings 11, 15 serve for filling the respective chambers 3, 5. The first chamber 3 is designed to be filled with a baby food concentrate, whereas the second chamber 5 is designed to be filled with a fluid. The fluid may be, for example, water (specifically sterile water) which, when mixed with the baby food concentrate, produces a baby milk or a baby puree. Preferably, the bag 1 is filled in advance (for example, already at home) to provide a pre-portioned bag 1 for a later time (for example, on the go).

In order to close the chambers 3, 5 for transport, the individual openings 11, 15 in the bag 1 can be closed by means of corresponding closures. For this purpose, the first connecting element 17 may be provided at the first opening 11 and the second connecting element 19 may be provided at the second opening 15. The connecting elements 17 and/or 19 can thereby be formed as circular elements, which are preferably made of plastic. In particular, it is advantageous in this case if the connecting elements 17, 19, in contrast to the bag 1 itself, are designed to be rigid or to have a higher rigidity. In order to connect the connecting elements 17, 19 to the bag 1, the connecting elements 17, 19 can be welded to the bag 1. On the first connecting element 17 there is the at least partially circumferential tensioning projection 42 as described above with respect to FIG. 1.

As shown in FIG. 9, the closure or closures may be in the form of cover s 21, each of which is which can be connected to the connecting elements 17, 19. The cover s 21 may be connected to the connecting elements by means of a hooking or clicking mechanism. Alternatively, the connecting elements 17, 19 and/or the cover s 21 may have one or more sealing lips which, when in contact with the respective other element, have both a sealing and a fixing function. FIG. 9, on the other hand, shows a screw mechanism. On the outer surface 23 of the connecting element 17 or 19 and on an inner surface 25 of the cover 21 there is in each case, at least in some areas, a thread 27 which engages in one another or interacts with one another in the connecting process.

In particular, the connecting element 17 or 19 can also be used to be connected to a dispenser designed, for example, to dispense a baby food concentrate into the first chamber 3. In particular, it is preferred that the bag 1 is compatible with a dispenser such as published in the publication WO 2017/121638 A1 and/or in the German patent application DE 10 2018 009 551, which are incorporated herein by reference in their entirety. The connecting element 17 and/or 19 may be connected to the dispenser directly herein or by means of an adapter. The amount of baby food concentrate may be manually adjusted at the dispenser. Alternatively, the dispenser dispenses predetermined or pre-portioned units to the bag 1. However, the dispenser may also comprise a sensor that automatically detects a connected bag 1 and, in a complementary manner, the size of the bag 1. In particular, based on the size of the connected connecting element 17, 19 the dispenser could detect whether it is the powder chamber or water chamber. Depending on which chamber the dispenser detects, the dispenser then dispenses either water or powder. The size of the connected connecting element 17, 19 may thereby also provide information to the dispenser as to how much water or powder is to be dispensed. Alternatively, an RFID tag could be provided or incorporated in or on the connecting element 17, 19 for this purpose. Once the dispenser detects a bag 1, a corresponding amount of a baby food concentrate can subsequently be dispensed automatically. This is also possible with respect to the second chamber 5 and the supply of a fluid. Thus, by being compatible with a dispenser, the chambers 3, 5 can be filled quickly and precisely.

If baby food is now required at a later time (e.g. while travelling, for example), only the separating region 7 can be at least partially opened. For this purpose, it is sufficient if force is applied to the bag 1 from the outside. If the separating region 7 is formed, for example, by a welding seam, the force is to be applied in such a way that the bag sides, which are connected to one another by the welding seam, at least partially separate from one another again as a result of the force applied. However, the bag sides themselves are not damaged in the process, so that leakage of the filled components is avoided. Once the separating region 7 has been opened, the filled components can be mixed together, so that subsequently the baby food is produced. Preferably, the bag 1 can be shaken.

The force to be applied may, for example, be applied by pushing on the bag 1 and/or by pulling the bag 1 substantially in the longitudinal direction of the bag BL.

Before or after opening the separating region 7, on one side of the bag 1, the cover 21 can be replaced specifically by a nipple. As soon as the separating region 7 is opened and the individual components are mixed in the bag 1, the baby can consume the baby food directly from the bag 1.

Contrary to the first embodiment of the bag 1 with one chamber, the at least one magnet 31 is here not arranged in a tensioning plate 46, but in the closure which closes the second opening 15. FIG. 9 shows a cover 21 on or in which the at least one magnet 31 is arranged as a second tensioning device 44.

FIG. 10 shows a bag 1 with two chambers according to the second embodiment.

The bag 1 is formed here as described with respect to FIG. 9. However, here there is no magnet as a second tensioning device 44 in the cover 21 for closing the second opening 15. Rather, here the tensioning strap 50 is attached to the cover 21.

FIG. 11 shows a bag 1 with two chambers according to the third embodiment.

The bag 1 is formed here as described with reference to FIG. 9. However, here there is no magnet as a second tensioning device in the cover 21 for closing the second opening 15. Rather, here the second tensioning projection 62 is arranged or formed on the second connecting element 19.

FIG. 12 shows a bag 1 with two chambers according to the fourth embodiment. This is identical to the bag 1 according to FIG. 7, but in contrast to FIG. 7 it has two chambers.

All embodiments described with two chambers can also be designed without a separating region 7 and consequently be used as a bag with only one chamber.

In order to supply the tempering module 100 with energy to control the temperature of the baby food, the tempering module 100 can be connected to a connection unit 200, as shown in FIG. 13.

For this purpose, tempering module connection contacts may be arranged in the tempering module base surface 106, via which the tempering module 100 may be connected to the connection unit 200. In particular, the heating mat 122 can thereby be connected.

In particular, the tempering module 100 is configured such thon the tempering module 100 can additionally be used as a holding device for the bag 1. In particular, after the baby food has been tempered in the bag 1, the baby can drink directly from the bag 1 which is held in the tempering module 100. Via this, the user can hold a stable element resembling a bottle while the flexible bag 1 is arranged inside the tempering module 100.

In the following, the connection unit 200 will now be described, which is shown, for example, in FIG. 13 (see steps 3 and 4 of the tempering process).

The connection unit 200 comprises a connection unit housing 202, the upper surface of which is a connection surface 204 onto which the tempering module 100, specifically the tempering module base surface 106, can be positioned. Preferably, the tempering module 100 can be clicked onto the connecting surface 204 using a click mechanism. This allows the tempering module 100 to be securely connected to the connection unit 200. Furthermore, the click mechanism can already be used to start the tempering process as soon as the tempering module 100 is clicked onto the connection surface 204.

Preferably, at least one rechargeable battery (e.g. a lithium polymer battery) is arranged inside the connection unit housing 202. This serves as an energy storage device, which supplies energy to the tempering module 100 when required to supply the heating element with power. The rechargeable battery makes it possible to always have energy available for tempering baby food, even when on the move—independently of a power socket. E.g. by means of a USB connection or a conventional power cable, the rechargeable battery can be at least partially charged again. The battery as well as the heating mat 122 are preferably designed in such a way that both liquid and frozen baby food can be heated in the tempering module 100.

Furthermore, a control unit may be arranged in the interior of the connection unit housing 202, which is connected to the battery in order to start and stop a tempering process by delivering energy to the heating element or by stopping the delivery. The duration of the tempering process may be determined by a fixed predefined time, or may occur as a function of an achieved temperature that has been reached in the tempering module interior 104. For this purpose, a sensor may be provided in the tempering module interior 104 which measures the temperature in the tempering module interior 104 (e.g. regularly or at different times) and transmits the measured data to the control unit. Depending on the measured temperatures, the control unit then controls the further tempering process. This function can also be used to maintain baby food in the tempering module 100 substantially at a predetermined or predeterminable temperature. For example, the desired temperature may be set at the connection unit 200. In addition, switches may be located on the connection unit 200 to trigger a start and/or stop of the tempering process. Alternatively or additionally, the connection unit 200 may be controllable via an app.

Alternatively, the tempering module 100 may be powered directly by means of a cable and a power outlet.

FIG. 13 shows specifically that a nipple 29 is connected to a connecting element 4, 17, 19. This protrudes from the tempering module 100 during the tempering process and can be used to consume the baby food after the tempering process. The bag 1 preferably remains in the tempering module 100 as a holding device.

In the embodiments of a bag 1 with two chambers described so far, the separating region 7 was preferably produced by means of a welding seam. In the following, further possibilities will be shown.

As shown in FIG. 14a), the separating region 7 may also have at least one folding edge 34. At the folding edge 34, the bag 1 is folded in the separating region 7 by an angle of up to about 180°, preferably so that the first chamber 3 and the second chamber 5 lie substantially on top of each other. The folded state is specifically fixed by a fixing adhesive tape 36, which is specifically arranged in the separating region 7 to fix the folded area. If the individual components are to be mixed to form a baby food, the first chamber 3 and second chamber 5 can be unfolded so that the separating region 7 is opened.

Further, the separating region 7 between the first chamber 3 and the second chamber 5 may comprise a clamp that clamps the bag 1 in the separating region 7. By opening the clamp, the separating region 7 is opened.

As a still further alternative, the separating region 7 may be formed by twisting the bag 1 in the separating region 7. The twisted state of the bag 1 may be fixed by a seal 38 (e.g. adhesive tape). If the user pulls on the bag 1 substantially in the longitudinal direction of the bag BL, the seal 38 breaks and the twist of the bag 1 may be released, allowing the components contained in the bag 1 to mix. In addition to the twist, the bag 1 may be folded as described above, as shown in FIG. 14b).

### LIST OF REFERENCE SIGNS

1 bag
2 chamber
3 first chamber
4 connecting element
5 second chamber
7 separating region
8 opening
9 first end of the bag
11 first opening
13 second end of the bag
15 second opening
17 first connecting element
19 second connecting element
21 cover
23 outer surface of the connecting element
25 inner surface of the cover
27 thread
29 nipples
31 magnet
34 folding edge
36 adhesive tape
38 seal
40 first tensioning device
42 circumferential tensioning projection on the connecting element
44 second tensioning device
46 tensioning plate
48 base surface of the bag
50 tensioning strap
52 fixation opening
54 tensioning cover
56 outer surface of the tensioning cover
58 first tensioning projection
60 outside of the tensioning cover
62 second tensioning projection
64 tension strut
100 tempering module
102 tempering module housing
104 tempering module interior
106 tempering module base surface
108 tempering module insertion opening
109 circumferential edge (first tensioning device)
111 tensioning support surface (first tensioning device)
112 inner wall
114 hinge
116 magnet (second tensioning device)
118 tensioning opening (second tensioning device)
120 bottom side of the tempering module
122 heating mat
124 circumferential tensioning recess (second tensioning device)
126 tensioning recess (second tensioning device)
200 connection unit
202 connection unit housing
204 connection area

1. Tempering module (100) for tempering baby food, specifically baby milk or baby puree, which is designed to receive a bag (1) for baby food; and
wherein the tempering module (100) comprises at least one heating element which is designed to heat an inner wall (112) of the tempering module (100) in order to control the temperature of the baby food contained in the bag (1), and
the tempering module (100) comprises at least one tensioning device which is designed to hold the inserted bag (1) in such a way that the bag (1) can be laid flat against the inner wall (112) of the tempering module (100).

2. The tempering module (100) according to claim 1, wherein the tempering module (100) comprises a rotationally symmetrical tempering module housing (102) with a tempering module base surface (106) and a tempering module insertion opening (108) via which the bag (1) can be inserted into the tempering module housing (102).

3. Tempering module (100) according to claim 2, wherein in the inner wall (112) of the tempering module housing (102) at least one tensioning recess (126) is formed as a tensioning device, which extends in a longitudinal direction (L).

4. The tempering module (100) according to claim 2, wherein a circumferential edge (109) on the tempering module insertion opening (108) or a tensioning support surface (111) adjacent to the tempering module insertion opening (108) forms a first tensioning device.

5. The tempering module (100) according to claim 4, wherein at least one magnet (116) is arranged as a second tensioning device in or on the tempering module base surface (106).

6. Tempering module (100) according to claim 4, wherein a tensioning opening (118) is formed in the tempering module base surface (106) as a second tensioning device, which is designed to guide a tensioning strap 50), which is attached to the inserted bag (1), out of the tempering module (100).

7. Tempering module (100) according to claim 4, wherein a circumferential tensioning recess (124) is formed as a second tensioning device in the inner wall (112) of the tempering module housing (102) adjacent to the tempering module base surface (106).

8. Tempering module (100) according to claim 1, wherein the tempering module housing (102) can be opened.

9. Bag (1) for storing baby food, specifically baby milk or baby puree, comprising at least one chamber (2; 3, 5) for containing the baby food;
wherein the chamber (2; 3, 5) has an opening (8; 11, 15) for filling the chamber (2; 3, 5);
a connecting element (4; 17, 19) is arranged at the opening (8; 11, 15);
a first tensioning device (40) is formed on an outer side (23) of the connecting element (4; 17, 19), the first tensioning device (40) comprising tensioning projection (42) that runs around at least in some regions;
a second tensioning device (44) is at one end (13) of the bag (1) which is opposite to the end (9) at which the connecting element (4; 17, 19) is arranged; and
the first and second tensioning devices (40, 44) are designed to hold the bag (1) inserted into a tempering module, preferably a tempering module (100) according to claim 1, in such a way that the bag can be laid flat (1) against an inner wall (112) of the tempering module (100) is possible.

10. Bag (1) according to claim 9, wherein the bag (1) comprises one chamber (2).

11. Bag (1) according to claim 10, wherein the second tensioning device (44) comprises a tensioning plate (46) which is fastened to a base surface (48) of the bag (1) and in or on which at least one magnet (31) is arranged.

12. Bag (1) according to claim 10, wherein the second tensioning device (44) comprises a tensioning strap (50) fastened to a base surface (48) of the bag (1) and extends in a longitudinal bag direction (BL).

13. Bag (1) according to claim 10, wherein the tensioning projection on the connecting element (4) is a first tensioning projection (58), and the opening at which the connecting element (4) is formed is a first opening (11);
the bag (1) comprises a second opening (15) formed on a side of the bag (1) which is opposite to the side on which the first opening (11) is formed;
a tensioning cover (54) is formed on the second opening (15), which closes the second opening (15) and on the outer side (60) of which a second tensioning projection (62) is formed around at least in some areas; and
the first and second tensioning projections (58, 62), are designed in such a way that when inserted into a tempering module (100), in such a way that the bag (1) is flat against an inner wall (112) of the tempering module (100).

14. Bag (1) according to claim 10, wherein the tensioning projection on the connecting element (4) is a first tensioning projection (58) and wherein the opening at which the connecting element (4) is formed is a first opening (11);
the bag (1) comprises a second opening (15) formed on a side of the bag (1) opposite to the side on which the first opening (11) is formed;
a tensioning cover (54) is formed on the second opening (15), which closes the second opening (15) and on the outer side (60) of which a second tensioning projection (62) is formed around at least some areas; and
the second tensioning projection (62) comprises at least one tensioning strut (64) which extends in the longitudinal direction (BL) of the bag and is connected to the first tensioning projection (58).

15. Bag (1) according to claim 10, wherein the connecting element (4) is designed to be connected to a breast pump and/or a dispenser for filling the chamber (2).

16. Bag (1) according to claim 9, wherein the bag (1) comprises a first chamber (3) and a second chamber (5) which are separated from one another by a separating region (7);
the first chamber (3) is designed to receive a baby food concentrate;
the second chamber (5) is designed to receive a fluid;
the first and second chamber (3, 5) are arranged along the bag's longitudinal direction (BL) of the bag (1);
the separating region (7) can be at least partially opened by applying force to the bag (1) in order to be able to mix the components contained in the first and second chamber (3, 5) to form baby food;
the connecting element having the first tensioning projection (58) is a first connecting element (17) and wherein the opening at which the first connecting element (17) is arranged, is a first opening (11);
a second opening (15) is formed at an end opposite to the end at which the first connecting element (17) is formed; and
a second connecting element (19) is formed on the second opening (15).

17. Bag (1) according to claim 16, wherein the second tensioning device (44) comprises at least one magnet (31) arranged in or on a closure which can be connected to the second connecting element (19).

18. Bag (1) according to claim 16, wherein the second tensioning device (44) comprises a tensioning strap (50) which is fastened to a closure which can be connected to the second connecting element (19), and the tensioning strap (50) extends in the longitudinal direction of the bag (BL).

19. Bag (1) according to claim 16, wherein on the outer side (23) of the second connecting element (19) a second tensioning projection (62) which is formed around at least some areas; and
the first and second tensioning projections (58, 62) are designed, in such a way that when inserted into a tempering module (100), the bag (1) is flat against an inner wall (112) of the tempering module (100).

20. Bag (1) according to claim 16, wherein on the outer side (23) of the second connecting element (19) a second tensioning projection (62) which is formed around at least in some areas; and
the second tensioning projection (62) comprises at least one tensioning strut (64) which extends in the longitudinal direction of the bag (BL) and is connected to the first tensioning projection (58).

21. Bag (1) according to claim 16, wherein the first and second connecting element (17, 19) are designed to be connectable to a dispenser so that the corresponding chamber can be filled by the dispenser.

22. Bag (1) according to claim 9, wherein the connecting element (4, 17, 19) can be connected to a nipple.

23. Process of tempering a baby food, specifically baby milk or puree, comprising:
Providing said tempering module (100) according to claim 9;
Providing said bag (1), which is filled with baby food;
insertion of the bag (1) into the tempering module (100) in such a way that the bag (1) is held flat against the inner wall (112) of the tempering module (100) by the tensioning device (40, 44) of the bag (1) and the at least one tensioning device of the tempering module (100); and
tempering the baby food.

24. Process according to claim 23, wherein providing a bag (1) comprises providing a bag (1) with one chamber (2), and
the bag (1) is inserted into the tempering module (100) in such a way that the tensioning projection (42) on the connecting element (4) rests on the first tensioning device of the tempering module (100) and the at least one magnet (31) on the bag (1) comes into contact with the at least one magnet (116) in or on the tempering module base surface (106).

25. Process according to claim 23, wherein providing a bag (1) comprises providing a bag (1) having one chamber (2), and
the bag (1) is inserted into the tempering module (100) in such a way that the tensioning projection (42) on the connecting element (4) rests on the first tensioning device of the tempering module (100) and the tensioning strap (50) of the bag (1) is at least partially withdrawn from the tensioning opening (118) in the tempering module base surface (106).

26. Process according to claim 23, wherein providing a bag (1) comprises providing a bag (1) having one chamber (2), and
the bag (1) is inserted into the tempering module (100) in such a way that the first tensioning projection (58) on the connecting element (4) rests on the first tensioning device of the tempering module (100) and the second tensioning projection (62) on the tensioning cover (54) engages into the second tensioning device of the tempering module (100).

27. Process according to claim 23, wherein providing a bag (1) comprises providing a bag (1) having two chambers (3, 5), and
the separating region (7) is at least partially opened by applying force and the components contained in the first and second chamber (3, 5) are mixed together to form a baby food before the bag (1) is inserted into the tempering module (100).

28. Process according to claim 23 or 27, wherein the bag (1) is inserted into the tempering module (100) in such a way that the at least one tensioning strut (64) of the bag (1) along the longitudinal direction (L) is inserted into the tensioning recess (126) of the tempering module (100).

29. Process according to claim 27, wherein the bag (1) is inserted into the tempering module (100) in such a way that the tensioning projection on the first connecting element (17) rests on the first tensioning device of the tempering module (100) and the at least one magnet (31) of the bag (1) comes into contact with the at least one magnet (116) in or on the tempering module base surface (106).

30. Process according to claim 27, wherein the bag (1) is inserted into the tempering module (100) in such a way that the tensioning projection on the first connecting element (17) rests on the first tensioning device of the tempering module (100) and the tensioning strap (50) of the bag (1) is at least partially withdrawn from the tensioning opening (118) in the tempering module base surface (106).

31. Process according to claim 27, wherein the bag (1) is inserted into the tempering module (100) in such a way that the tensioning projection on the first connecting element (17) rests on the first tensioning device of the tempering module (100) and the second tensioning projection (62) on the second connecting element (19) engages into the second tensioning device of the tempering module.
